(19) United States
(12) Patent Application Publication
(10) Pub. No.: US 2023/0419933 A1
(43) Pub. Date: Dec. 28, 2023

(54) PEDAL DEVICE

(71) Applicant: YAMAHA CORPORATION, Hamamatsu-shi (JP)

(72) Inventors: Shin YAMAMOTO, Hamamatsu-shi (JP); Kenichi NISHIDA, Hamamatsu-shi (JP); Ryosuke NAKAMURA, Hamamatsu-shi (JP); Takahiro MIZUGUCHI, Hamamatsu-shi (JP); Masaaki MITA, Hamamatsu-shi (JP)

(21) Appl. No.: 18/465,379

(22) Filed: Sep. 12, 2023

Related U.S. Application Data
(63) Continuation of application No. PCT/JP2022/013211, filed on Mar. 22, 2022.

(30) Foreign Application Priority Data
Mar. 24, 2021 (JP) 2021-050494

(51) Int. Cl. G10H 1/34

(52) U.S. Cl. CPC G10H 1/348; G10H 2220/281

(57) ABSTRACT

A pedal device includes a case, a foot lever including a first portion located inside the case and a second portion located outside the case, the foot lever being arranged to be rotatable with respect to the case, a center of rotation of the foot lever being located between the first portion and the second portion, a first sensor detecting a position of the foot lever between a rest position and an end position, and a reaction force member contacting with the foot lever and applying a reaction force while the foot lever rotates from the rest position to the end position, the reaction force member being located corresponding to a portion opposite to the center of rotation of the first portion.

This application is a Continuation of International Patent Application No. PCT/JP2022/013211, filed on Mar. 22, 2022, which claims the benefit of priority to Japanese Patent Application No. 2021-050494, filed on Mar. 24, 2021, the entire contents of which are incorporated herein by reference.

### FIELD

The present disclosure relates to a pedal device.

### BACKGROUND

A pedal unit used in an electronic musical instrument at least detects a state in which a pedal is depressed (an end position) and a state in which a pedal is not depressed (a rest position), and transmits a detection result to a sound source device, thereby controlling a sound signal generated in the sound source device. Various techniques have been applied to such a pedal unit in order to obtain an operation feeling of a pedal of an acoustic piano. For example, Japanese Laid-Open Patent Publication No. 2004-334008 discloses a technique for providing hysteresis for a damper load (reaction force) against a depression of a pedal. Further, Japanese Laid-Open Patent Publication No. 2012-145609, Japanese Laid-Open Patent Publication No. 2012-13895, Japanese Laid-Open Patent Publication No. 2012-13894 disclose techniques for a reaction force characteristic in an area (half pedal area) which is between an area on the rest position side, and an area on the end position side, and gives a different change from two areas to a performance sound.

### SUMMARY

According to an embodiment of the present disclosure, a pedal device is provided including a case, a foot lever including a first portion located inside the case and a second portion located outside the case, the foot lever being arranged to be rotatable with respect to the case, a center of rotation of the foot lever being located between the first portion and the second portion, a first sensor detecting a position of the foot lever between a rest position and an end position, and a reaction force member contacting with the foot lever and applying a reaction force while the foot lever rotates from the rest position to the end position, the reaction force member being located corresponding to a portion opposite to the center of rotation of the first portion, a position of the foot lever that changes a performance sound is calibrated in response to changes in the reaction force based on first information set based on a first position of the foot lever in a state where the reaction force member is in contact with the foot lever and information relating to the position of the foot lever detected by the first sensor.

Further, according to an embodiment of the present disclosure, a pedal device is provided including a case, a foot lever arranged in the case and arranged to be rotatable, a first sensor detecting a position of the foot lever between a rest position and an end position, and a reaction force member contacting with the foot lever and applying a reaction force while the foot lever rotates from the rest position to the end position, the first sensor and the reaction force member are arranged on an integral structure.

### BRIEF DESCRIPTION OF DRAWINGS

FIG. 1 is a diagram showing an appearance of an electronic keyboard device according to an embodiment.

FIG. 2 is a schematic cross-sectional view showing a configuration of a pedal unit according to an embodiment.

FIG. 3 is a graph showing an example of output characteristics of a stroke sensor.

FIG. 4 is an example of an enlarged plan view of an elastic member when viewed from a keyboard body side.

FIG. 5 is a block diagram showing a configuration of an electronic keyboard device according to an embodiment.

FIG. 6 is a functional block diagram of a control unit.

FIG. 7 is a graph showing a reaction force characteristic in a foot lever.

FIG. 8 is a graph showing an example of output characteristics of a stroke sensor.

FIG. 9 is a schematic cross-sectional view showing a configuration of a pedal unit according to an embodiment.

FIG. 10 is a schematic cross-sectional view showing a configuration of a pedal unit according to an embodiment.

FIG. 11 is an operation control flow diagram of a pedal unit.

FIG. 12 is a rewrite control flow diagram of a stored output value.

FIG. 13 is a graph showing an example of output characteristics of a stroke sensor.

FIG. 14 is a reset control flow diagram of rewritten information.

FIG. 15 is a schematic cross-sectional view showing a configuration of a pedal unit according to an embodiment.

FIG. 16 is an example of an enlarged plan view of an elastic member when viewed from a keyboard body side.

FIG. 17 is a graph showing an example of output characteristics of a stroke sensor.

FIG. 18 is a schematic cross-sectional view showing a configuration of a pedal unit according to an embodiment.

FIG. 19 is a schematic cross-sectional view showing a configuration of a pedal unit according to an embodiment.

FIG. 20 is an operation control flow diagram of a control unit.

FIG. 21 is a rewrite control flow diagram of stored offset information.

FIG. 22 is a graph showing an example of output characteristics of a stroke sensor.

FIG. 23 is a schematic cross-sectional view showing a configuration of a pedal unit according to an embodiment.

FIG. 24 is a graph showing an example of output characteristics of a stroke sensor.

FIG. 25 is a schematic cross-sectional view showing a configuration of a pedal unit according to an embodiment.

FIG. 26 is an operation control flow diagram of a control unit.

### DESCRIPTION OF EMBODIMENTS

Hereinafter, an embodiment of the present disclosure will be described in detail with reference to the drawings. The following embodiments are examples, and the present disclosure should not be construed as being limited to these embodiments. In the drawings referred to in the present embodiment, the same or similar parts are denoted by the same symbols or similar symbols (only denoted by A, B, etc. after the numerals), and repetitive description thereof may be omitted. In the drawings, dimensional ratios may be different from actual ratios, or part of the configuration may be omitted from the drawings for clarity of explanation.

Among acoustic pianos, a pedal of an upright piano and a pedal of a grand piano are different from each other in function and structure. For example, a distance between a center of rotation of the pedal and a front end of the pedal is different between the grand piano and the upright piano. This distance is smaller for the grand piano than for the upright piano. As a result, the grand piano and the upright piano have different aspects of rotation when the pedal is depressed. On the other hand, a conventional pedal unit used in an electronic musical instrument all have a center of rotation set at a position corresponding to the pedal of the upright piano. Therefore, it is desired to develop a pedal device capable of obtaining an operation feeling equivalent to the pedal of the grand piano.

In addition, there is a product variation in each member used in the electronic musical instrument pedal unit, and there may be a variation in the operation due to aging. Due to this variation, there are cases where a feeling of operation of the pedal (change of a load on the pedal) and a change of a performance sound are shifted by the operation of the pedal. In particular, a control of pedal depression amount (stroke amount), a reaction force, and a performance sound in the half pedal area is required to be precise, and it is necessary to avoid the influence of the variation.

An object of the present disclosure is to stabilize a position of a pedal, a change in a load to the pedal, and a change in a performance sound.

According to the present disclosure, a change in a load with respect to a pedal and a timing of a change in a performance sound are able to be accurately and finely matched.

### First Embodiment

### [1-1. Basic Configuration of Electronic Keyboard Device]

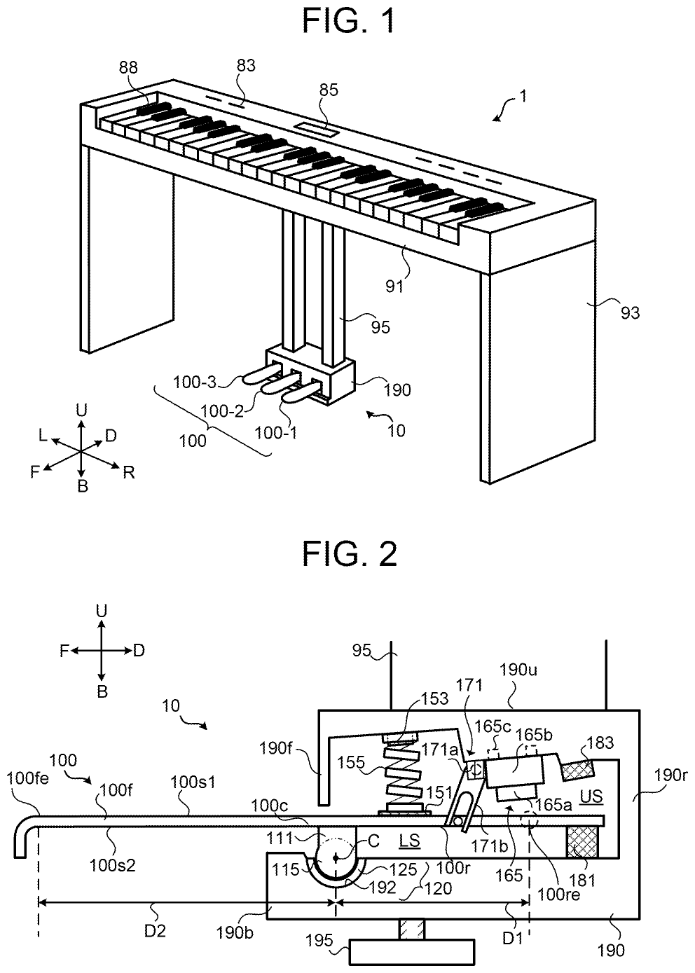

FIG. 1 is a diagram showing an appearance of an electronic keyboard device according to an embodiment. An electronic keyboard device 1 includes a pedal unit 10, a keyboard body 91, a support plate 93 that supports the keyboard body 91 at a predetermined height, and a support column 95 that suspends and supports the pedal unit 10 from the keyboard body 91. The pedal unit 10 may be separable from the keyboard body 91. In this case, the pedal unit 10 and the support column 95 may be separated from each other, and the support column 95 and the keyboard body 91 may be separated from each other.

The keyboard body 91 includes an operation unit 83, a display unit 85, and a keyboard unit 88 composed of a plurality of keys. The pedal unit 10 includes a case 190 and at least one foot lever 100 protruding from the case 190. In this example, the pedal unit 10 includes three foot levers 100-1, 100-2, and 100-3. In terms of function, the foot lever 100-1 corresponds to a damper pedal, the foot lever 100-2 corresponds to a sostenuto pedal, and the foot lever 100-3 corresponds to a shift pedal. In the following description, the three foot levers 100-1, 100-2, and 100-3 are shown as foot levers 100 unless they are separately described. The foot lever 100 may also be referred to as a pedal arm.

As shown in FIG. 1, a front direction F, a depth direction D, an upper direction U, a bottom direction B, a left direction L, and a right direction R are defined with reference to a user (a player) who plays the electronic keyboard device 1. In other words, the front direction F and the depth direction D are along the longitudinal direction of the key. The longitudinal direction of the key may be referred to as the front-rear direction. The left direction L and the right direction R are along a key array direction. The key array direction may be referred to as a left-right direction. The right direction R corresponds to a treble side of the key. A plane including the front-rear direction and the left-right direction is sometimes referred to as a horizontal plane. The upper direction U and the bottom direction B are along a vertical direction. The vertical direction may be referred to as an up-down direction. In the following description of the figures, similar definitions are followed.

According to the pedal unit 10 of an embodiment, by adopting a structure different from the conventional structure as its internal structure, it is possible to bring an operation feeling of the pedal closer to an operation feeling of the pedal of the ground piano. Hereinafter, each configuration of the electronic keyboard device 1 will be described.

### [1-2. Configuration of Pedal Unit]

A configuration of the pedal unit 10 will be described. In the following description, one foot lever 100 is focused on.

FIG. 2 is a schematic cross-sectional view showing a configuration of a pedal unit according to the first embodiment. FIG. 2 shows a state in which the foot lever 100 is not depressed, that is, a state in which the foot lever 100 is in a rest position. The pedal unit 10 includes the foot lever 100, the case 190, an elastic member 155, a lower stopper 181, an upper stopper 183, a stroke sensor 171, and an elastic member 165.

The case 190 accommodates part of the foot lever 100. In this example, the pedal unit 10 includes an auxiliary tool 195 for assisting in fixing a position of the case 190 relative to a floor on the underside of a bottom portion 190b. The case 190 is made of plastic and includes the bottom portion 190b, a ceiling portion 190u, and side portions. The side portions are wall portions connecting the bottom portion 190b and the ceiling portion 190u. In FIG. 2, a front portion 190f and a rear portion 190r of the side portions are shown. Portions of the side portions arranged in the left direction L and the right direction R are not shown. There is an opening between the front portion 190f and the bottom portion 190b. The foot lever 100 is arranged such that part of the foot lever 100 is inside the case 190 and a remaining portion is outside the case 190. The foot lever 100 is rotatably arranged with respect to the case 190 by a shaft 115 and a bearing 120 which will be described below. A center of rotation C is located inside the case 190. The opening has a size that does not interfere with a range of rotation of the foot lever 100.

The foot lever 100 is formed of metal and has a longitudinal in the front-rear direction. In the following description, in the foot lever 100, an area which is in the depth direction D with respect to the center of rotation C and inside the case 190 is referred to as a first area 100r (a first portion), and an area which is in the front direction F with respect to the center of rotation C and outside the case 190 is referred to as a second area 100f (a second portion). A surface of the foot lever 100 in the upper direction U is referred to as an upper surface 100s1, and a surface in the bottom direction B is referred to as a bottom surface 100s2. It is assumed that the upper surface 100s1 and the bottom surface 100s2 do not include a portion bent in the bottom direction B at the tip of the foot lever 100 in the second area 100f.

An area (hereinafter, referred to as a central area 100c) located substantially at the center of the foot lever 100 in the longitudinal direction is connected to the shaft support portion 111 on the bottom surface 100s2. The shaft 115 is connected to a tip of the shaft support portion 111. That is, the shaft support portion 111 connects the shaft 115 and the foot lever 100, and supports the shaft 115 with respect to the foot lever 100.

The shaft 115 forms a rotation axis extending along the left-right direction, and has an arc shape at an edge portion of a cross section perpendicular to the rotation axis. The arc shape corresponds to part of a circle centered on the center of rotation C.

The elastic member 155, the elastic member 165, the stroke sensor 171, the lower stopper 181, and the upper stopper 183 are arranged in an inner space of the case 190.

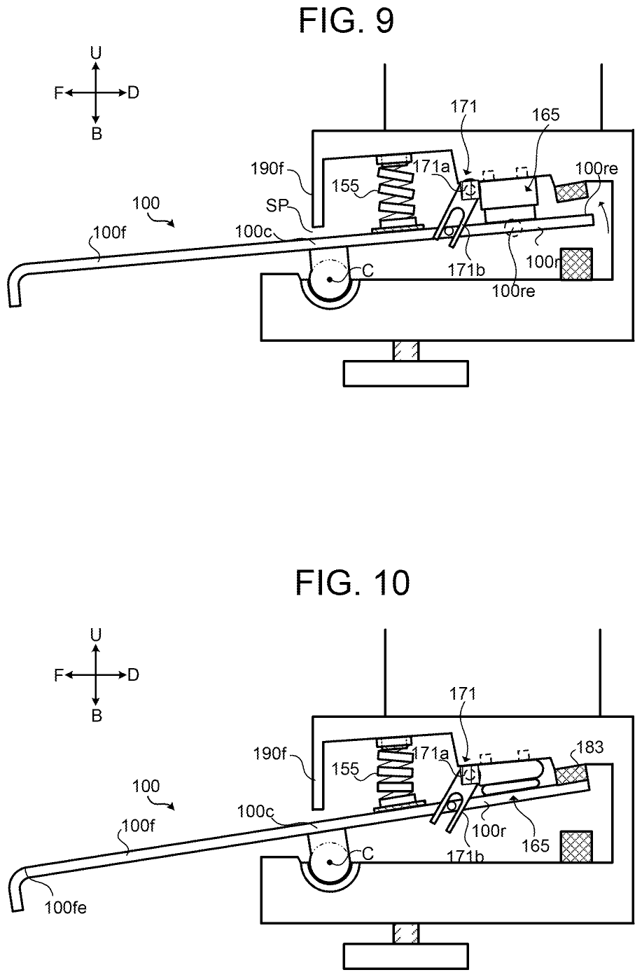

In this example, although the elastic member 155 is a spring made of metal, the elastic member 155 may not be made of metal, and may not be a spring shape. That is, the elastic member 155 may be any member that generates an elastic force by elastic deformation. An upper end of the elastic member 155 is supported by a support member 153 fixed to the ceiling portion 190u. The lower end portion of the elastic member 155 is supported by a support member 151 fixed to the upper surface 100s1 of the first area 100r. The axial direction of the spring forming the elastic member 155 preferably coincides with the rotational direction (circumferential direction) in the area in contact with the first region 100r at any position in the range of rotation of the foot lever 100 (for example, an end position, the rest position, or a position where the elastic member 165 and the foot lever 100 come into contact with each other (see FIG. 9)).

The elastic member 155 is supported by the support members 151 and 153 in a state of being compressed more than a natural length, and provides an elastic force (reaction force) to the first area 100r so as to hold the foot lever 100 in the rest position. The elastic force (reaction force) includes components in the bottom direction B with respect to the first area 100r. The elastic member 155 presses the first area 100r against the lower stopper 181 by the elastic force, and a reaction force is applied to the second area 100f of the foot lever 100 moving in the bottom direction B. Therefore, the elastic member 155 can also be referred to as a reaction force member (first reaction force member).

The lower stopper 181 is arranged on the bottom portion 190b and contacts the bottom surface 100s2 of the first area 100r of the foot lever 100. The lower stopper 181 contacts part of the first area 100r that is located in the depth direction D rather than the elastic member 155 (in this case, an end portion in the first area 100r side of the foot lever 100). In other words, a portion of the foot lever 100 to which a force (reaction force) is applied by the elastic member 155 exists between the shaft 115 and the lower stopper 181. In this state, the rest position of foot lever 100 is defined. The more the position of the lower stopper 181 is away from the center of rotation C, the higher a positioning accuracy can be. By applying force to the first area 100r by the elastic member 155 by such a positional relationship, the foot lever 100 is stably supported in the pedal unit 10.

The upper stopper 183 is arranged on the ceiling portion 190u and contacts the upper surface 100s1 of the first area 100r of the foot lever 100. The upper stopper 183 contacts the end portion in the first area 100r side of the foot lever 100 in this example. In this state, the end position of foot lever 100 is defined. The more the position of the upper stopper 183 is away from the center of rotation C, the higher the positioning accuracy can be. In this way, the foot lever 100 can rotate between the rest position and the end position (i.e., the range of rotation).

The stroke sensor 171 is arranged at an upper portion of the foot lever 100. In this example, the stroke sensor 171 is arranged at the upper portion of the foot lever 100 and in a vicinity of the elastic member 165. Specifically, the stroke sensor 171 includes a sensing unit 171a and an engaging portion 171b. The sensing unit 171a is fixed to the ceiling portion 190u of the case 190. The engaging portion 171b engages part of the first area 100r of the foot lever 100. The stroke sensor 171 detects a behavior of the foot lever 100. Specifically, the engaging portion 171b of the stroke sensor 171 rotates in accordance with a rotation of the first area 100r. Information detected by the sensing unit 171a changes in conjunction with a movement of the engaging portion 171b. Accordingly, a position of the foot lever 100 between the rest position and the end position (for example, rotation amount) can be detected. In the present embodiment, a variable resistor is used for the stroke sensor 171. Although the stroke sensor 171 is arranged in the vicinity of the elastic member 165 in the above example, the arrangement of the stroke sensor 171 is not particularly limited as long as the position of the foot lever 100 (rotation amount) can be detected.

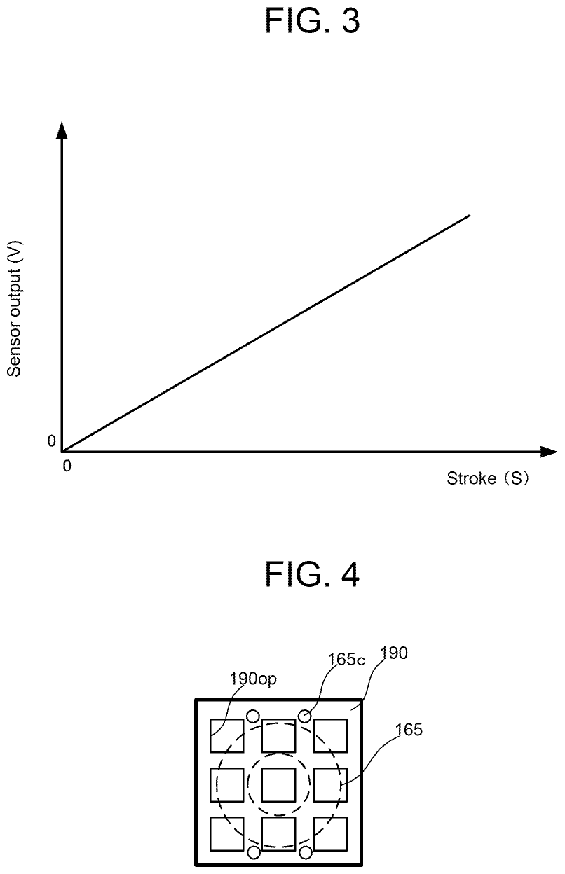

FIG. 3 is a graph showing an example of output characteristics of the stroke sensor 171. In FIG. 3, a horizontal axis represents a stroke S. The stroke S indicates a position of the foot lever (for example, a position of the foot lever 100 that contacts the elastic member 165 or a position of a tip 100fe of the second area 100f) when the rest position is set as a reference value (S0). A vertical axis represents a sensor output value V (for example, a voltage value) corresponding to the stroke S. As shown in FIG. 3, the sensor output value V is approximately proportional to a stroke of the damper pedal, and the sensor output value increases with increasing stroke. The stroke sensor 171 may continuously output an output value corresponding to the stroke amount of the foot lever 100.

In the elastic member 165, the first area 100r of the foot lever 100 contacts the elastic member 165 in a state where the foot lever 100 is in the middle of moving from the rest position to the end position. The elastic member 165 elastically deforms when a force is applied from below by the foot lever 100 and applies an elastic force (reaction force) to the first area 100r. This elastic force (reaction force) further applies a reaction force to the second area 100f of the foot lever 100 moving in the bottom direction B. Therefore, the elastic member 165 may be referred to as a reaction member (second reaction member). The elastic member 165 is formed of an elastic material such as rubber. The elastic member 165 forms a space therein. That is, the elastic member 165 has a dome shape. Further, in the present embodiment, the elastic member 165 has a two-stage dome shape including an upper dome portion 165a and a lower dome portion 165b. By having the two-stage dome shape, individual variations of the elastic member are reduced. Accordingly, an inclination between the output value V output from the stroke sensor 171 (variable resistor) and a position of the foot lever (stroke S) can be made constant.

FIG. 4 is an example of an enlarged plan view of the elastic member 165 of the pedal unit 10 when viewed from the keyboard body 91 side. As shown in FIG. 4, the elastic member 165 is fixed to the case 190 via a support portion 165c for fixing. The case 190 has a hole 190op. Thus, when the elastic member 165 is pressed, the air inside the elastic member 165 is discharged to the outside. As a result, the elastic member 165 can be stably deformed.

### [1-3. Block Diagram of Electronic Keyboard Device]

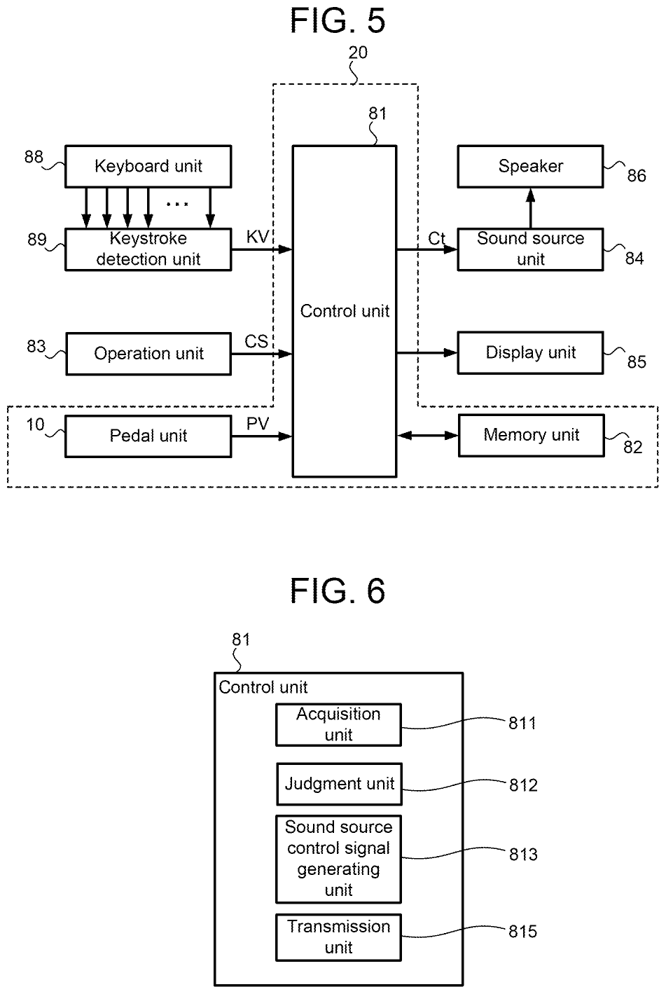

FIG. 5 is a block diagram showing a configuration of an electronic keyboard device according to an embodiment. The electronic keyboard device 1 includes, a control unit 81, a memory unit 82, the operation unit 83, a sound source unit 84, the display unit 85, a speaker 86, the keyboard unit 88, and a keystroke detection unit 89 in addition to the pedal unit 10 described above. The control unit 81, the memory unit 82, the operation unit 83, the sound source unit 84, the display unit 85, the speaker 86, the keyboard unit 88, and the keystroke detection unit 89 are arranged in the keyboard body 91.

The keystroke detection unit 89 detects a depression operation on a key included in the keyboard unit 88, and outputs a key signal KV corresponding to a detection result to the control unit 81. The key signal KV includes information corresponding to the key to be operated and an operation amount of the key. The pedal unit 10 outputs a pedal signal PV corresponding to a depression of the foot lever 100 to the control unit 81. The pedal signal PV includes information corresponding to a pedal to be operated and an operation amount of the pedal. Specifically, the pedal signal PV includes a signal (output value V) output from the stroke sensor 171. The control unit 81 can calculate a position of the foot lever 100 (depression amount of the foot lever 100) based on the detection result of the stroke sensor 171.

The operation unit 83 includes an operation device such as a knob, a slider, a contact sensor, and a button, and receives an instruction from the user to an electronic keyboard apparatus 1. The operation unit 83 outputs an operation signal CS corresponding to the received user's instruction to the control unit 81.

The memory unit 82 is a memory unit such as a nonvolatile memory, and includes an area for storing a control program executed by the control unit 81. The control program may be provided from an external device. When the control program is executed by the control unit 81, various functions are realized in the electronic keyboard device 1.

Further, the memory unit 82 stores a position of the foot lever 100 when the foot lever 100 and the elastic member 165 come into contact with each other, and information (also referred to as first information) regarding a position of the foot lever 100 when the foot lever is rotated by a predetermined amount in an end position direction from a position of the foot lever 100 when the foot lever 100 and the elastic member 165 come into contact with each other in advance. Specifically, the memory unit 82 storages an output value V1 (also referred to as a first output value) of the stroke sensor 171 corresponding to a position of the foot lever 100 when the foot lever 100 and the elastic member 165 are in contact (also referred to as a stroke S1 or a first position), an output value V2 (also referred to as a second output value or the first information) of the stroke sensor 171 corresponding to a position of the foot lever 100 when the foot lever 100 and the elastic member 165 are in contact and the foot lever rotates in the direction toward the end position by a certain amount, and a predetermined range (output values V3 to V4) with V2 as a median value. The output value V3 indicates a value of V2−α. The output value V4 indicates a value of V2+α.

The control unit 81 is an example of a computer including an arithmetic processor such as a CPU and a memory unit such as a RAM and a ROM. The control unit 81 executes a control program stored in the memory unit 82 by the CPU, and implements various functions in the electronic keyboard device 1 in accordance with instructions described in the control program.

FIG. 6 is a functional block diagram of the control unit 81. As shown in FIG. 6, the control unit 81 includes an acquisition unit 811, a judgment unit 812, a sound source control signal generating unit 813, and a transmission unit 815 as functional units. The acquisition unit 811 receives various signals from each device. For example, the acquisition unit 811 acquires (receives) position information of the foot lever 100 sent from the stroke sensor 171 as an output value. The judgment unit 812 judges the output value acquired from the stroke sensor 171. The sound source control signal generating unit 813 generates a sound source control signal Ct based on a key signal KV, a pedal signal PV, an operation signal CS, and the like. The sound source control signal may include, for example, a MIDI (Musical Instruments Digital Interface) signal. The sound source control signal Ct includes a signal for changing the performance sound. The transmission unit 815 transmits various kinds of command information to each device. For example, the transmission unit 815 transmits the generated sound source control signal to the sound source unit 84.

The sound source unit 84 includes a DSP (Digital Signal Processor). The sound source unit 84 generates a sound signal based on the sound source control signal Ct transmitted from the control unit 81. In other words, the sound source unit 84 generates a sound signal in response to an operation on the key of the keyboard unit 88 and an operation on the foot lever 100 of the pedal unit 10. The sound source unit 84 may supply the generated sound signal to the speaker 86. The speaker 86 generates a sound corresponding to the sound signal by amplifying and outputting the sound signal supplied from the sound source unit 84. The display unit 85 includes a display device such as a liquid crystal display, and displays various screens under the control of the control unit 81. A touch panel may be configured by combining a contact sensor with the display unit 85. In the present embodiment, the pedal unit 10, the control unit 81, and the memory unit 82 can be collectively referred to as a pedal device 20.

### [1-4. Operation and Reaction Force Characteristic of Pedal Unit]

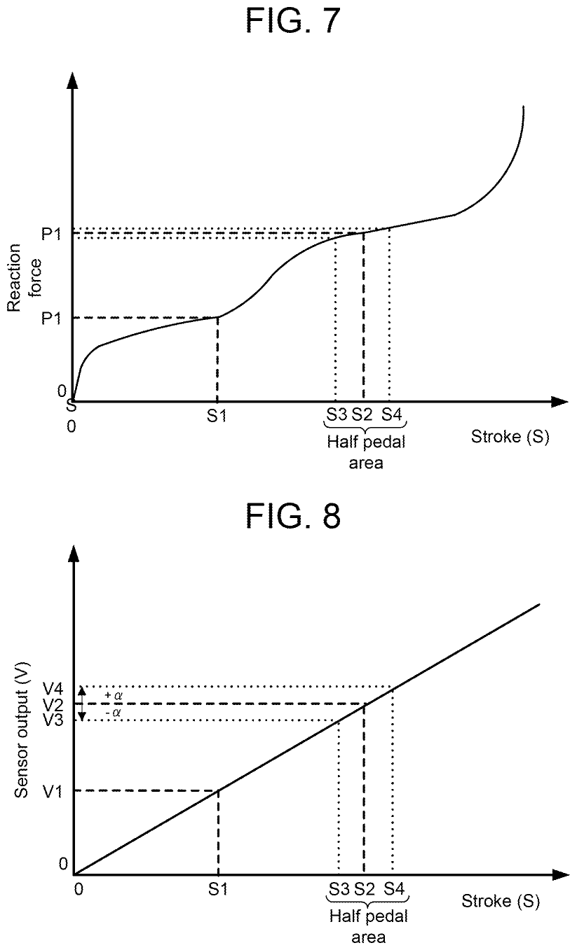

Next, a rotating operation of the foot lever 100 from the rest position to the end position will be described. FIG. 7 is a graph showing a reaction force characteristic in the foot lever. FIG. 8 is a graph showing an example of output characteristics of the stroke sensor 171. FIG. 9 and FIG. 10 are schematic cross-sectional views of the pedal unit 10 when the foot lever 100 is rotated. In FIG. 7, the horizontal axis represents a position of the foot lever 100 (stroke S), and the vertical axis represents the reaction force applied to the second area 100f of the foot lever 100.

In the pedal unit 10, when the foot lever 100 is depressed and rotated (an area from strokes S0 to S1 in FIG. 7), the second area 100f which is a portion to be depressed is lowered, and the first area 100r is raised. Accordingly, the position of the foot lever 100 (stroke S) is detected by the stroke sensor 171. In this case, the elastic member 155 is gradually compressed to increase the elastic force. Consequently, the force (reaction force) required to lower the second area 100f is increased. The change in the reaction force is large at the beginning of the rotation of the foot lever 100 and then increases at a constant rate of change until the stroke S1. Further, as shown in FIG. 8, the output value V of the stroke sensor 171 also increases in accordance with a change in the position of the foot lever 100 (stroke S). The pedal signal PV of the pedal unit 10 is transmitted to the control unit 81 as the output value V of the stroke sensor.

When the foot lever 100 is further depressed and rotated, part of the first area 100r contacts the elastic member 165 in a state that the foot lever 100 is in the middle of moving from the rest position to the end position as shown in FIG. 9.

When the foot lever 100 is further depressed and rotated (from the stroke S1 to S2 (or S3 to S4) in FIG. 7), in addition to increasing the elastic force due to the deformation of the elastic member 155, the elastic force accompanying the deformation of the elastic member 165 is applied. Consequently, the force (reaction force) required to lower the first area 100r of the foot lever 100 is also greatly increased.

When the foot lever 100 is further depressed and rotated, the foot lever reaches an area (half pedal area) where a rate of change of the reaction force is minimized (an area of S3 to S4 where the stroke S2 is the median value). The user can perceive that the half pedal area has been reached by perceiving the change in the reaction force.

When the foot lever 100 is further depressed and rotated (from the stroke S4), as shown in FIG. 10, the first area 100r of the foot lever 100 contacts the upper stopper 183, so that the foot lever 100 reaches the end position. When the first area 100r contacts the upper stopper 183, the rate of change of the reaction force rapidly increases, and the reaction force also increases.

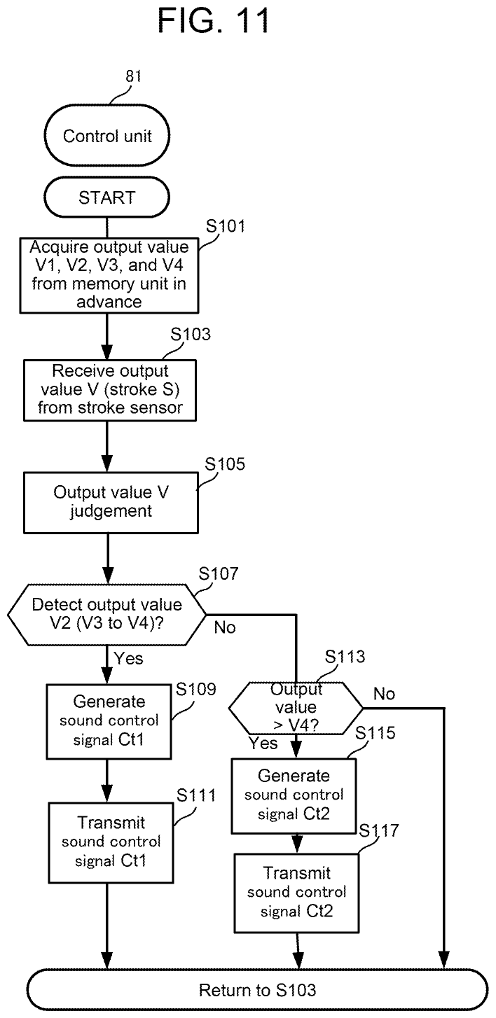

FIG. 11 is a process flow diagram of the control unit 81 when the foot lever is depressed. In FIG. 11, the acquisition unit 811 acquires the output value V1 of the stroke sensor 171 corresponding to the position of the foot lever 100 (stroke S1) when the foot lever 100 and the elastic member 165 are in contact, the output value V2 (also referred to as a second output value) of the stroke sensor 171 corresponding to the position of the foot lever 100 (stroke S2, also referred to as second position) when the foot lever 100 and the elastic member 165 are in contact and then the foot lever rotates (offsets) in the direction toward the end position by a certain amount, and a predetermined range with V2 as a median value (output values V3 to V4) from the memory unit 82 (performs reading process) in advance (S101).

Next, the acquisition unit 811 receives the output value V transmitted from the stroke sensor 171 (S103). In this case, the judgment unit 812 performs a process of judging the acquired output value (S105).

In the case where the output value is V2 (or the value ranging from V3 to V4) (S107; Yes), the sound source control signal generating unit 813 generates a signal (sound source control signal Ct1) that gives a change to the performance sound corresponding to the half pedal area (S109). The transmission unit 815 transmits the sound source control signal Ct1 to the sound source unit 84 (S111).

In the case where the output value is not V2 (or the value ranging from V3 to V4) but is larger than V4 (S113; Yes), the sound source control signal generating unit 813 generates a signal that gives a change to the performance sound corresponding to an area on the end position side (sound source control signal Ct2) (S115). The transmission unit 815 transmits the sound source control signal Ct2 to the sound source unit 84 (S117).

In the case where the output value does not correspond to the above (S113; No), the sound source control signal may not be generated. In a stage where the respective processes are completed, the process returns to S103 again. In addition, in the above description, although the case where the foot lever is rotated in the direction from the rest position to the end position is shown, the same also applies to the case where the foot lever is rotated in the direction from the end position to the rest position.

As described above, in the present embodiment, the memory unit 82 stores the output value V1 of the stroke sensor 171 corresponding to the position of the foot lever when the foot lever 100 and the elastic member 165 are in contact, and the output value V2 (or the output values V3 and V4) of the stroke sensor 171 corresponding to a position of the foot lever when the foot lever 100 and the elastic member 165 are in contact and then the foot lever rotates (offsets) by a certain amount in advance. Thus, even if there is a variation in the operation of the member (for example, the elastic member 165), a position of the foot lever at a time of shipment or at a pre-inspection stage, in particular, a position of the foot lever (depression amount) in the half pedal area, a change in the reaction force with respect to the foot lever, and a change in the performance sound can be adjusted (calibrated) in advance.

Therefore, as in the case of depressing the damper pedal of the acoustic piano, the performance sound can be changed in accordance with the change in the reaction force. That is, by using the present embodiment, it is possible to stabilize a position of the pedal, a change in the load on the pedal, and the change in the performance sound.

Further, in the present embodiment, it is desirable that the stroke S2 (or the range from the stroke S3 to the stroke S4), that is, the position of the tip 100fe of the foot lever 100 in the second area 100f in the half pedal area in FIG. 7 includes a range within 5 mm before and after in the rotational direction, more preferably a range within 2 mm before and after, with reference to the position where the reaction force from the elastic member 165 is applied to the foot lever 100 by 0.5 kg or more. In this area, the user can change the performance sound while feeling the reaction force, so that the user can perform the desired performance.

In the present embodiment, the pedal unit 10 used in the electronic keyboard device 1 is configured such that the first area 100r and the second area 100f are arranged with the center of rotation C interposed therebetween, and the rotation of the foot lever 100 is realized by a seesaw type of rotation. In this way, it is possible to reduce the lower space LS of the bottom surface 100s2 of the first area 100r while increasing an upper space US on the upper surface 100s1 of the first area 100r. The pedal unit 10 is arranged in a portion close to an installation surface of the electronic keyboard device 1. Therefore, the degree of freedom in design can be improved by making a portion in the bottom direction B (lower space LS) from the foot lever 100 as small as possible.

In addition, in the pedal unit 10 according to the present embodiment, the elastic member 165 is arranged on the upper space US of the case 190 that is farther from the shaft 115 (center of rotation C) than the elastic member 155. In this case, the shaft 115 (center of rotation C) of the foot lever 100 is arranged near the center in the longitudinal direction (center area 100c). In this case, a length D1 from the shaft 115 (center of rotation C) to a portion 100re that contacts the elastic member 165 in the first area 100r of the foot lever 100 is preferably at least ⅓ or more of a length D2 from the shaft 115 (center of rotation C) to the tip 100fe of the second area 100f of the foot lever 110. Specifically, the length D1 may be ⅓ or more and ½ or less, ½ or more, ⅔ or more, or 1 or more of the length D2. In the case where the elastic member 165 is arranged under the foot lever 100, the ratio described above can be applied by increasing the size of the case 190 or by being arranged outside the case 190 or in an environment close to the external space even inside the case 190. Therefore, the arrangement of the elastic member 165 is limited. However, by having the configuration described above as in the present embodiment, a space in which the elastic member 165 is arranged can be widened. Accordingly, the elastic member 165 can be arranged in a wide space in the case 190, and the size of the elastic member 165 can be increased. If the size of the elastic member 165 is increased, the load to the foot lever 100 can be more precisely controlled. In addition, by increasing the size of the elastic member 165, a durability of the elastic member 165 can be improved.

In addition, in the present embodiment, the pedal unit 10 (foot lever 100) has a seesaw type structure. Therefore, in the conventional pedal unit, the reaction force member (elastic member 165) that needs to be arranged below the foot lever 100 is arranged in the upper space US of the foot lever 100. Accordingly, the locking portion (mounting portion) of the stroke sensor 171 is also arranged close to the elastic member 165 in the upper space US of the foot lever 100. In this case, the stroke sensor 171 and the elastic member 165 are arranged on the same plane (upper surface) of the case 190. In the present embodiment, the case 190 is a structure having an integral structure. The integral (or monolithic) structure refers to a unitary structure in which the entire structure is continuous. By using the present embodiment, even if the size of each member such as the stroke sensor 171 and the elastic member 165 is different (varied) from the design value, the influence thereof can be reduced. Therefore, the performance sound can be stably changed in accordance with the change of the reaction force.

### Second Embodiment

In the present embodiment, an example of changing information corresponding to the output value of the stroke sensor stored in the memory unit will be described.

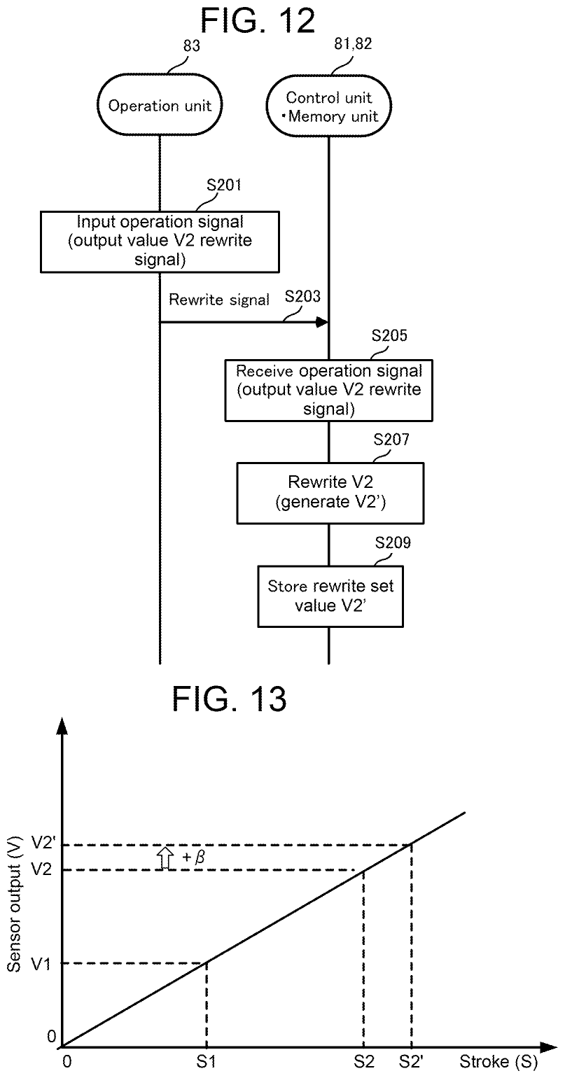

FIG. 12 is a control flow for changing the stored output value of the stroke sensor. In the present embodiment, the user inputs an operation signal CS (rewrite signal) for changing the output value V2 (first information), which is a set value for generating the sound source control signal by using the operation unit 83 (S201). In this example, the user inputs an arbitrary numerical value to the operation unit 83. More specifically, in terms of an operation output of a MIDI standard in the foot lever 100, any numerical value in a range of numerical values from 0 to 127 (for example, 70) is input. The operation unit 83 transmits the operation signal CS (rewrite signal) to the control unit 81 (S203). The acquisition unit 811 of the control unit 81 receives the operation signal CS (rewrite signal) from the operation unit 83 (S205). The control unit 81 rewrites the value of the output value V2 (generates an output value V2′) based on the manipulation signal CS (rewrite signal) (S207). V2′ is a value obtained by adding β to the output value V2. The transmission unit 815 transmits the rewritten output value V2′ to the memory unit 82, and the rewritten output value V2′ is stored in the memory unit 82 (S209). FIG. 13 is a graph showing an example of output characteristics of a stroke sensor after rewriting. As shown in FIG. 13, with rewriting from the output value V2 to V2′, a sound source control signal corresponding to the half pedal area is generated when the output value V2′ is detected.

Therefore, by using the present embodiment, it is possible to change the playing sound with a stroke of the foot lever which is personally easiest for the user to play.

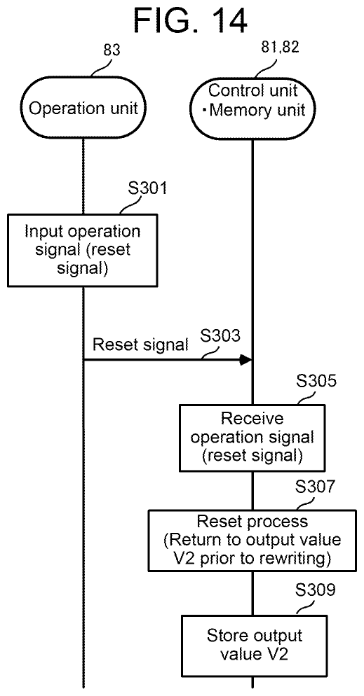

In the present embodiment, although the example of rewriting the set value (output value V2) is shown, the present disclosure is not limited thereto. For example, the rewritten output value V2 may be reset to the value prior to being rewritten. FIG. 14 is a control flow for resetting the rewritten output value of the stroke sensor. The user inputs a reset operation signal CS (also referred to as a reset signal) to the output value V2 prior to rewriting using the operation unit 83 (S301). The operation unit 83 transmits the operation signal CS to the control unit 81 (S303). The acquisition unit 811 receives the operation signal CS for resetting from the operation unit 83 (S305). The control unit 81 changes (resets) the value of the output value V2 to the value prior to rewriting based on the operation signal CS for resetting (S307). The reset output value V2 is stored in the memory unit 82 (S309).

### Third Embodiment

In the present embodiment, a pedal unit different from the first embodiment will be described. Specifically, an example will be described in which a contact sensor that contacts a protruding portion arranged in the elastic member is provided. Note that a configuration that overlaps the first embodiment will not be described as appropriate.

### [3-1. Configuration of Pedal Unit]

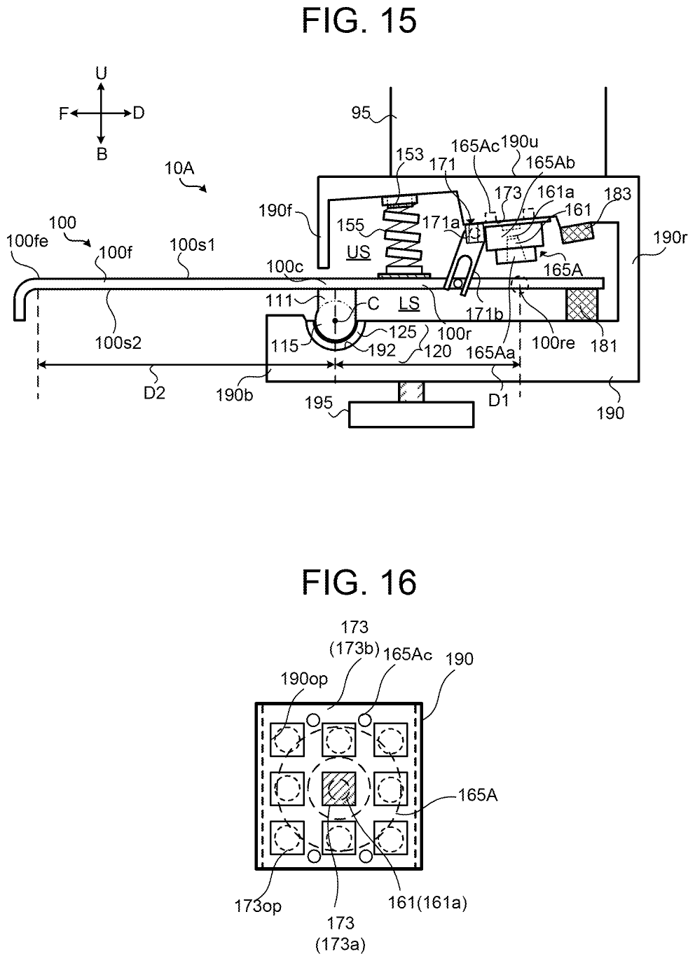

FIG. 15 is a schematic cross-sectional view of a pedal unit 10A. As shown in FIG. 15, the pedal unit 10A includes an elastic member 165A and a contact sensor 173 in addition to the foot lever 100, the case 190, the elastic member 155, the lower stopper 181, the upper stopper 183, and the stroke sensor 171.

The elastic member 165A contacts the first area 100r of the foot lever 100 in a state where the foot lever 100 is in the middle of moving from the rest position to the end position. The elastic member 165A is elastically deformed and generates an elastic force when receiving a force from below by the foot lever 100. This elastic force (reaction force) applies a downward force to the first area 100r of the foot lever 100. The elastic member 165A is formed of an elastic material such as rubber. The elastic member 165A forms a space therein. That is, the elastic member 165A has a dome shape. More specifically, the elastic member 165A has a two-stage dome configuration including an upper dome portion 165Aa and a lower dome portion 165Ab.

Further, in the present embodiment, the elastic member 165A includes a protruding portion 161 protruding toward an inner space. The protruding portion 161 is integrally molded with the upper dome portion 165Aa. A tip 161a of the protruding portion 161 may be arranged with a metallic material.

The contact sensor 173 includes a sensing unit 173a and a circuit board 173b on which the sensing unit 173a is arranged. The contact sensor 173 is arranged on the ceiling portion 190u of the case 190, and detects contact (contact data) with a predetermined detecting position.

In the present embodiment, the elastic member 165A is arranged so as to cover the detecting position (sensing unit 173a) of the contact sensor 173 from below. The elastic member 165A deforms when subjected to a force from below. Due to this deformation, when the protruding portion 161 is in contact with the detecting position of the contact sensor 173, the contact sensor 173 outputs a predetermined detection signal. The detection signal is also included in the pedal signal PV.

FIG. 16 is an example of an enlarged plan view of the elastic member 165A, the case 190, and the contact sensor 173 of the pedal unit 10A when viewed from the keyboard body 91 side. The elastic member 165A is fixed to the case 190 via a support portion 165Ac for fixing together with the contact sensor 173. As a result, an impact on the circuit board 173b caused by a contact between the elastic member 165A and the contact sensor 173 can be mitigated. In addition, the case 190 has the hole 190op, and the circuit board 173b has a hole 173op. Accordingly, air in the elastic member 165A is easily moved, and therefore, when the elastic member 165A is pressed toward the first area 100r of the foot lever 100, air inside the elastic member 165 is easily discharged to the outside. Consequently, the elastic member 165A can be stably deformed. Further, the elastic member 165A may be fixed to the hole 190op and the hole 173op by passing the support portion 165Ac therethrough.

### [3-2. Operation and Reaction Force Characteristic of Pedal Unit]

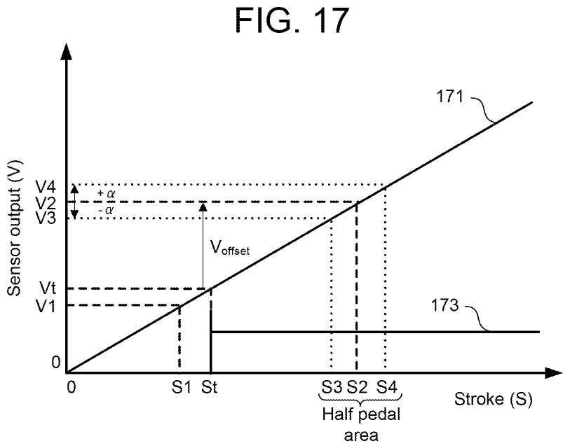

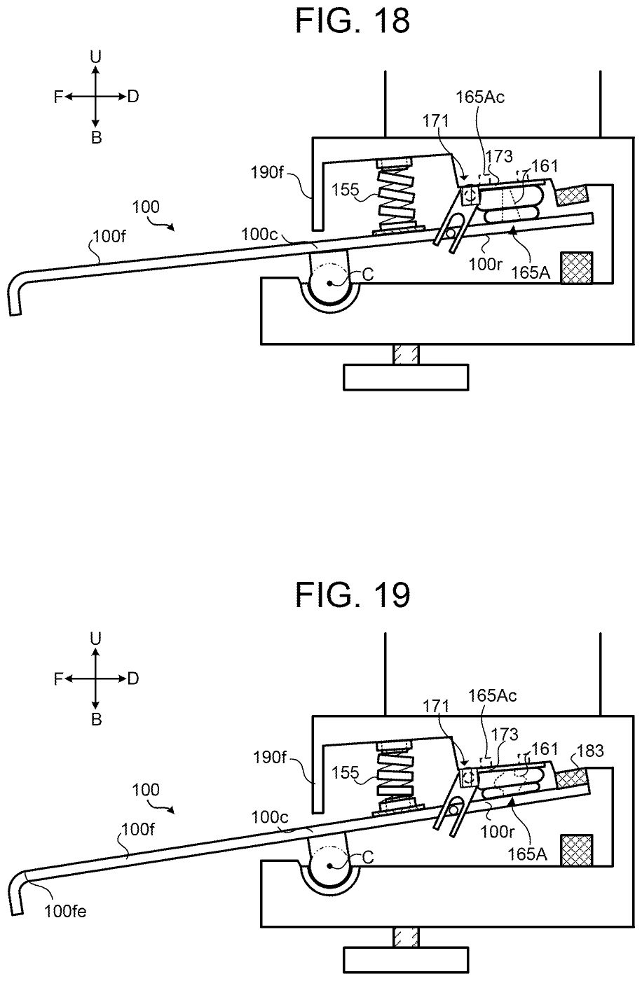

Next, an operation in which the foot lever 100 rotates from the rest position toward the end position will be described. FIG. 17 is a graph showing an example of output characteristics of the stroke sensor 171 and the contact sensor 173. FIG. 18 and FIG. 19 are schematic cross-sectional views of the pedal unit 10 when the foot lever 100 is rotated. In the present embodiment, for the purposes of explanation, the following explanation begins at a point when the foot lever 100 is depressed by the user and the foot lever 100 and the elastic member 165A are in contact with each other.

When the foot lever 100 is further depressed and rotated (an area from the stroke S1 to S2 in FIG. 17), the first area 100r of the foot lever 100 is rotated upward. In this case, the position of the foot lever 100 (stroke S) is detected by the stroke sensor 171. The pedal signal PV of the pedal unit 10 is transmitted to the control unit 81 as the output value of the stroke sensor in a range from the stroke S1 to S2. In this case, in addition to the increase in the elastic force caused by the deformation of the elastic member 155, the elastic force caused by the deformation of the elastic member 165 is applied. Consequently, the force (reaction force) for lowering the first area 100r of the foot lever 100 is also greatly increased.

Further, when the user depresses the second area 100f of the foot lever 100, the first area 100r of the foot lever 100 rotates upward, and as the elastic member 165A deforms, the protruding portion 161 and the contact sensor 173 come into contact with each other (see FIG. 18). The contact sensor 173 detects touched information (also referred to as contact information and first information). The contact sensor 173 transmits the contact information as an electrical signal to the control unit 81. Further, in this case, the stroke sensor 171 detects the output value Vt corresponding to the position (also referred to as the first position and a stroke St) of the foot lever 100 (the first area 100r and the tip 100fe of the second area 100f) at the time of contact, and transmits the detected output value Vt to the control unit 81 (S413).

When the foot lever 100 is further depressed and rotated, an area (half pedal area) where the rate of change of the reaction force is minimized is reached (an area in S3 to S4 where the stroke S2 is the median value, see FIG. 7). The user can perceive that the half pedal area has been reached by perceiving this change in the reaction force.

When the foot lever 100 is further depressed and rotated (from the stroke S4), as shown in FIG. 19, the first area 100r of the foot lever 100 contacts the upper stopper 183, so that the foot lever 100 reaches the end position. When the first area 100r contacts the upper stopper 183, the rate of change of the reaction force rapidly increases again, and the reaction force further increases.

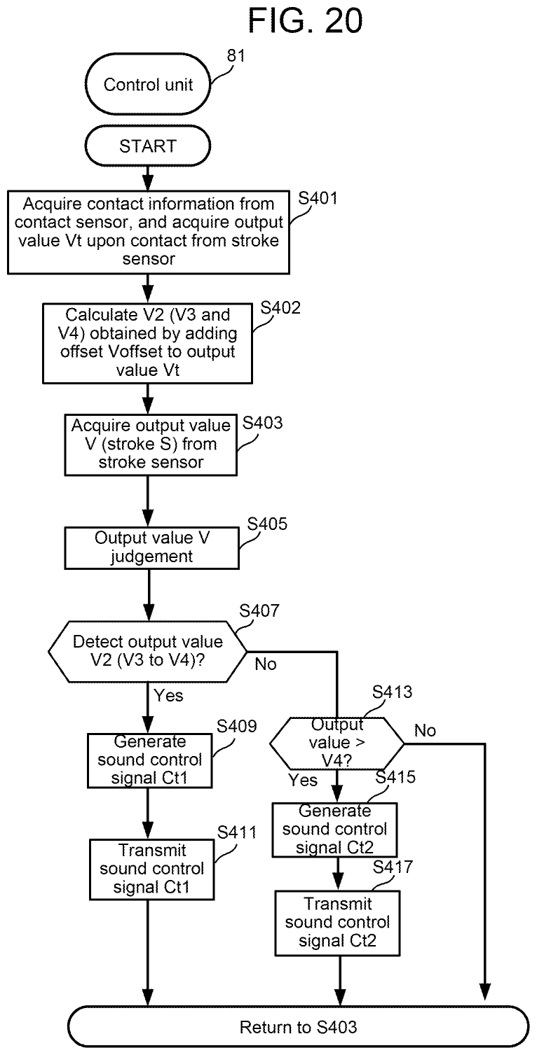

FIG. 20 is a process flow diagram of the control unit 81 when the foot lever 100 is depressed. In FIG. 20, the acquisition unit 811 acquires (receives) the transmitted contact information which is received by the contact sensor 173 and the output value Vt corresponding to the position of the foot lever 100 when the contact is made from the stroke sensor (S401). The control unit 81 calculates V2 obtained by adding an offset Voffset to the acquired output value Vt and a predetermined range (output values V3 to V4) in which V2 is set as the median value (S402). The output value V3 is a value obtained by subtracting a certain amount (α) from V2. The output value V4 is a value obtained by adding a certain amount (α) to V2. That is, the output values V2, V3, and V4 are as follows.

Output value V2=Vt+Voffset

Output value V3=Vt+Voffset−α

Output value V4=Vt+Voffset+α

Next, the acquisition unit 811 receives the output value V transmitted from the stroke sensor 171 (S403). In this case, the judgment unit 812 performs a process of judging the acquired output value (S405).

In the case where the output value is V2 (or a value ranging from V3 to V4) (S407; Yes), the sound source control signal generating unit 813 generates a signal (sound source control signal Ct1) that changes the performance sound corresponding to the half pedal area (S409). The transmission unit 815 transmits the sound source control signal Ct1 to the sound source unit 84 (S411).

In the case where the output value is not V2 (or a value ranging from V3 to V4) but is larger than V4 (S413; Yes), the sound source control signal generating unit 813 generates a signal (sound source control signal Ct2) that gives a change to the performance sound corresponding to the area on the end position side (S415). The transmission unit 815 transmits the sound source control signal Ct2 to the sound source unit 84 (S417).

If the output value does not correspond to the above (S413; No), the sound source control signal may not be generated. The process returns to S403 again when the respective processes are completed. In addition, although the case where the foot lever is rotated in the direction from the rest position to the end position is described above, the same applies to the case where the foot lever is rotated in the direction from the end position to the rest position. In this case, the control unit 81 may process by using the output value V2 (or the output values V3 to V4) calculated above.

In the present embodiment, the performance sound is changed in the half pedal area by using the information detected by the contact sensor 173 and the output value and the offset information corresponding to the position of the foot lever 100 detected by the stroke sensor 171. As a result, even in a case where a shape variation, a change in age, or the like of the elastic member occurs, it is possible to adjust (calibrate) the position of the foot lever, in particular, the position of the foot lever in the half pedal area (depression amount), the change in the reaction force with respect to the foot lever, and the change in the performance sound in real time.

Therefore, as in the case of depressing the damper pedal of the acoustic piano, the performance sound can be changed in accordance with the change in the reaction force. That is, by using the present embodiment, it is possible to stabilize the change in the position of the pedal, the change in the load on the pedal, and the change in the performance sound.

In addition, it is preferable that the position of the tip 100fe in the second area 100f of the foot lever 100 in the half pedal area includes a range within 5 mm before and after, more preferably a range within 2 mm before and after, in the rotational direction with reference to a position where the reaction force from the elastic member 165A is applied to the foot lever 100 by 0.5 kg or more. In this area, the user can change the performance sound while feeling a moderate reaction force, so that the user can perform a desired performance.

Further, in the present embodiment, the contact sensor 173 is arranged on the ceiling portion 190u of the case 190. Therefore, it is possible to prevent the circuit board 173b of the contact sensor 173 from being dirty or short-circuited by part of the circuit board due to dust or the like.

Further, in the present embodiment, the protruding portion 161 of the elastic member 165A and the contact sensor 173 are in contact with each other. The elastic member 165A may be detected by using a sensor that differs from the contact sensor 173 in the process of elastic deformation. For example, a sensor that is interlocked with an elastic force (reaction force) generated by the elastic member 165A is applicable to the present disclosure. Specifically, a variable resistor may be arranged instead of the contact sensor. That is, the pedal unit may comprise two variable resistors. Accordingly, the position of the foot lever in the vicinity of the half pedal area can be detected in more detail. Alternatively, a sensor that detects the amount of deformation of the elastic member 165 may be used instead of the contact sensor.

Further, in the present embodiment, although an example has been described in which the control unit 81 transmits a signal for changing the performance sound to the sound source unit 84 when V2 in which the offset Voffset is added to the output value Vt when the contact sensor 173 and the protruding portion 161 come into contact with each other is detected, the present disclosure is not limited thereto. For example, a signal for changing the performance sound at a timing when the contact sensor 173 and the protruding portion 161 come into contact with each other may be transmitted to the sound source unit 84. In this case, the offset Voffset is “0”. Further, the contact sensor 173 may detect that the first area 100r of the foot lever 100 and the elastic member 165A are in contact with each other.

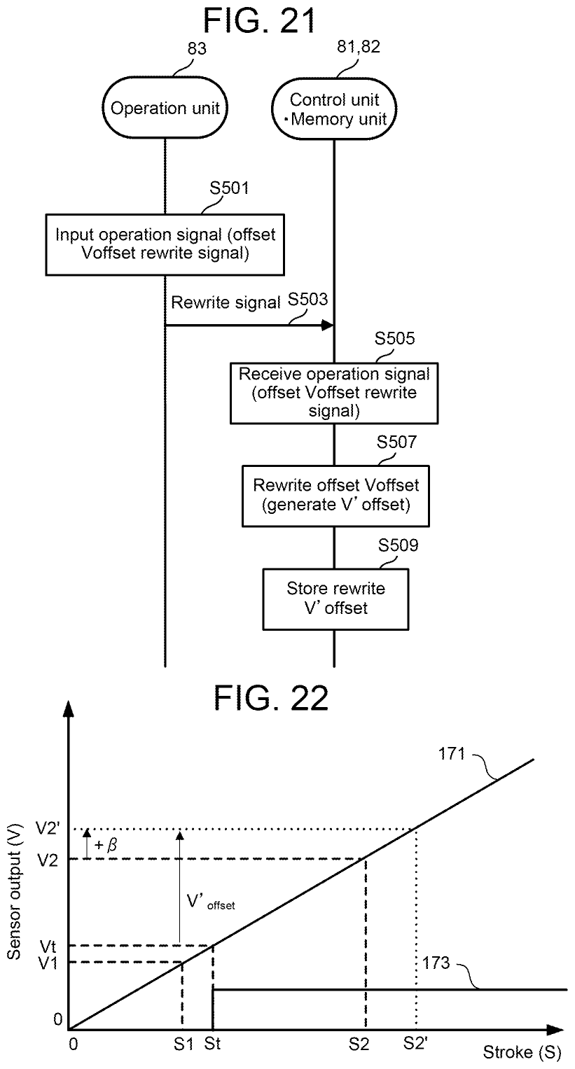

In the present embodiment, the offset Voffset may be changed as appropriate. FIG. 21 is a control flow for changing the offset Voffset. In the present embodiment, the user inputs an operation signal CS (rewrite signal) for changing the output value V2 (first information) using the operation unit 83 (S501). More specifically, in terms of the operating power of the MIDI standard in the foot lever 100, any numerical value in a numerical value range from 0 to 127 (for example, 5) is input. The operation unit 83 transmits the operation signal CS to the control unit 81 (S503). The acquisition unit 811 of the control unit 81 receives the operation signal CS from the operation unit 83 (S505). The control unit 81 changes the value of the offset Voffset based on the control signal (S507). The transmission unit 815 transmits the changed output value V2′ to the memory unit 82, and the offset V′offset is stored in the memory unit 82 (S509). FIG. 22 is a graph showing an example of output characteristics of the stroke sensor 171 and the contact sensor 173 after the offset change. In this case, the offset value V′offset is obtained by adding an additional offset 13 to Voffset. This makes it possible for the user to change the performance sound with the offset rotation amount of the foot lever that is personally easiest to play.

The rewritten offset V′offset may be reset to a Voffset prior to rewriting. Specifically, the user inputs a reset operation signal CS (also referred to as a reset signal) to the output value V2′ prior to rewriting using the operation unit 83. The acquisition unit 811 receives the reset operation signal CS from the operation unit 83. The control unit 81 changes the offset V′offset to the offset Voffset prior to rewriting based on the reset operating signal. The changed offset V′offset is stored in the memory unit 82.

Further, in the present embodiment, although an example has been described in which the output value corresponding to the stroke of the foot lever 100 is continuously output and transmitted, the present disclosure is not limited thereto. The stroke sensor 171 may extract information regarding the position of the foot lever 100 (stroke amount) based on a predetermined condition, and transmit only the extracted information to the control unit 81. Specifically, the output value V corresponding to the stroke amount may be extracted at regular intervals. Further, after the contact sensor 173 detects the contact information, the stroke sensor 171 may continuously transmit the output value. Accordingly, it is possible to reduce the load applied to the calculation in the control unit 81.

Further, in the present embodiment, although an example has been described in which the control unit 81 transmits a signal for changing the performance sound to the sound source unit 84 by detecting that the contact sensor 173 is in contact with the protruding portion 161 and detecting the position of the foot lever 100 by the stroke sensor 171, the present disclosure is not limited thereto. For example, in the case where a malfunction occurs in the contact sensor 173 and the stroke sensor 171 detects a signal exceeding a preset threshold, the control unit 81 may transmit a signal for changing the performance sound to the sound source unit 84. This makes it possible to change the performance sound even in the case where a malfunction (failure or the like) occurs in the contact sensor 173.

Further, in the present embodiment, the shaft 115 (center of rotation C) of the foot lever 100 is arranged near the center in the longitudinal direction (center area 100c). In this case, the length D1 from the shaft 115 (center of rotation C) to the portion 100re that contacts the elastic member 165 in the first area 100r of the foot lever 100 is preferably at least ⅓ or more of the length D2 from the shaft 115 (center of rotation C) to the tip 100fe of the second area 100f of the foot lever 110. Specifically, the length D1 may be ⅓ or more and ½ or less, ½ or more, ⅔ or more, or 1 or more of the length D2. Accordingly, it is possible to improve the accuracy of the contact timing between the foot lever 100 and the elastic member 165 due to the depression amount of the foot lever 100 by the user. Therefore, since the detection accuracy of the sensor arranged inside the elastic member 165 can be increased, the timing accuracy in the control of changing the performance sound can also be increased.

### Fourth Embodiment

In the present embodiment, the pedal unit including the two variable resistors described in the third embodiment will be described in more detail. In addition, descriptions of configurations overlapping those of the first to third embodiments are omitted as appropriate.

### [4-1. Configuration of Pedal Unit]

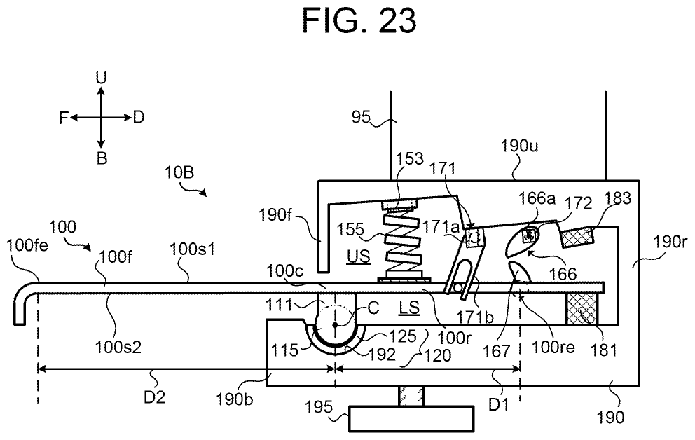

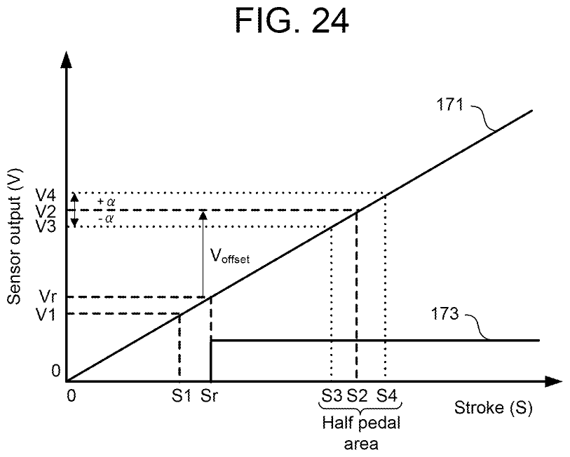

FIG. 23 is a schematic cross-sectional view of a pedal unit 10B. As shown in FIG. 23, the pedal unit 10B includes an elastic member 166 and a protruding portion 167 in addition to the foot lever 100, the case 190, the elastic member 155, the lower stopper 181, the upper stopper 183, and the stroke sensor 171.

The protruding portion 167 is arranged on the upper surface of the foot lever 100 in the first area 100r. A material of the protruding portion 167 may be the same as or different from the material of the foot lever 100.

The elastic member 166 comes into contact with the protruding portion 167 in a state that the foot lever 100 is in the middle of moving from the rest position to the end position. When the elastic member 166 receives a force from below by the protruding portion 167 of the foot lever 100, the elastic member 166 rotates clockwise via a center of rotation 166a and generates an elastic force in a direction opposite to the direction of rotation. This elastic force (reaction force) applies a downward force to the first area 100r of the foot lever 100. The center of rotation 166a of the elastic member 166 is arranged with an elastic material such as a rubber or a spring.

The elastic member 166 includes a rotation sensor 172. The rotation sensor 172 is arranged in a vicinity of the center of rotation 166a of the elastic member 166. The rotation sensor 172 detects the behavior of the elastic member 166. Specifically, the information detected by the rotation sensor 172 in conjunction with the rotation of the elastic member 166 changes. Thus, the rotation amount of the elastic member 166 can be detected. In the present embodiment, a variable resistor is used for the rotation sensor 172. That is, in the present embodiment, it can be said that two variable resistors are used.

In the present embodiment, when the elastic member 166 rotates by a predetermined rotation amount, the rotation sensor 172 outputs a predetermined detection signal. The detected signal is also included in the pedal signal PV.

### [4-2. Operation and Reaction Force Characteristics of Pedal Unit]

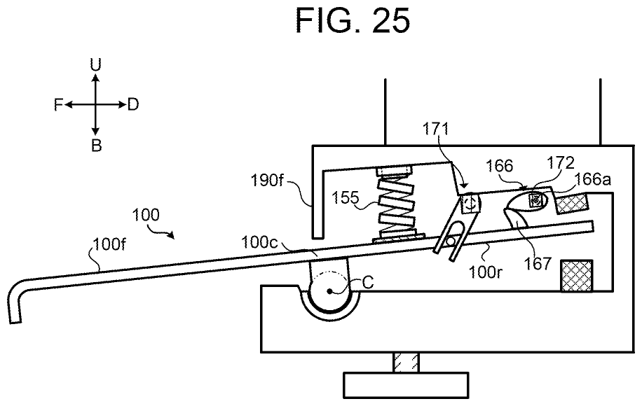

Next, an operation in which the foot lever 100 rotates from the rest position toward the end position will be described. FIG. 24 is a graph showing an example of output characteristics of the stroke sensor 171 and the rotation sensor 172. FIG. 25 is a schematic cross-sectional view of the pedal unit 10 when the foot lever 100 is rotating. In the present embodiment, for the purposes of explanation, the following explanation begins at a point when the foot lever 100 is depressed by the user, and the protruding portion 167 of the foot lever 100 and the elastic member 166 come into contact with each other (FIG. 25). In addition, for the purposes of explanation, the descriptions of the first and third embodiments are also used as appropriate.

When the foot lever 100 is depressed and rotated, the first area 100r of the foot lever 100 is rotated upward. In this case, the position of the foot lever 100 (stroke S) is detected by the stroke sensor 171. The pedal signal PV of the pedal unit 10 is transmitted to the control unit 81 as the output value of the stroke sensor in the range from the stroke S1 to S2 in FIG. 24. In this case, in addition to the increase in the elastic force caused by the deformation of the elastic member 155, the elastic force caused by the rotation of the elastic member 166 is applied. Consequently, the force (reaction force) for lowering the first area 100r of the foot lever 100 is also greatly increased.

Further, when the user depresses the second area 100f of the foot lever 100, the first area 100r of the foot lever 100 rotates upward, and when the elastic member 166 rotates to a predetermined rotation amount, the rotation sensor 172 detects predetermined rotation information (also referred to as first information). The rotation sensor 172 transmits predetermined rotation information as an electric signal to the control unit 81. In this case, the stroke sensor 171 detects the output value Vr corresponding to the position (also referred to as the first position and the stroke Sr) of the foot lever 100 (the first area 100r and the tip 100fe of the second area 100f) at the time of touching, and transmits the detected output value to the control unit 81.

When the foot lever 100 is further depressed and rotated, the foot lever 100 reaches an area (half pedal area) in which the rate of change of the reaction force decreases according to a shape of the protruding portion 167 and a shape of the elastic member 166 (an area in S3 to S4 where the stroke S2 is the median value, see FIG. 7). The user can perceive that the half pedal area has been reached by perceiving the change in the reaction force.

When the foot lever 100 is further depressed and rotated (from the stroke S4), the first area 100r of the foot lever 100 contacts the upper stopper 183, and the foot lever 100 reaches the end position. When the first area 100r contacts the upper stopper 183, the rate of change of the reaction force rapidly increases again, and the reaction force further increases.

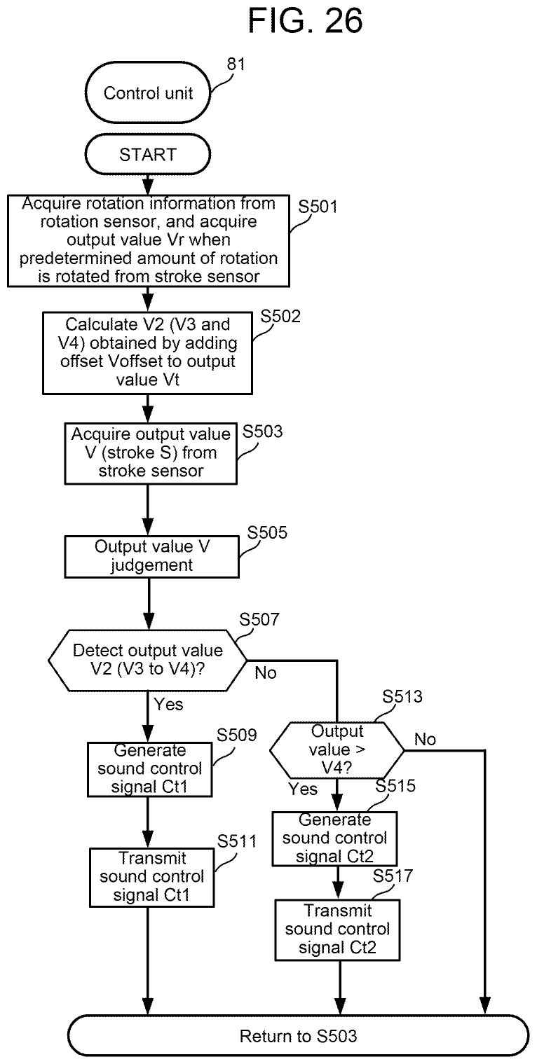

FIG. 26 is a process flow diagram of the control unit 81 when the foot lever 100 is depressed. In FIG. 26, the acquisition unit 811 receives rotation information (first information) corresponding to a predetermined rotation amount transmitted from the rotation sensor 172, and also acquires (receives) an output value Vr corresponding to the position of the foot lever 100 when touched from the stroke sensor 171 (S501). The control unit 81 calculates V2 obtained by adding the offset Voffset set to the acquired output value Vr and a predetermined range (output values V3 to V4) in which V2 is set as the median value (S502). The output value V3 is a value obtained by subtracting a certain amount (α) from V2. The output value V3 is a value obtained by adding a certain amount (α) to V2. That is, the output values V2, V3, and V4 are as follows.

Output value V2=Vr+Voffset

Output value V3=Vr+Voffset−α

Output value V4=Vr+Voffset+α

Next, the acquisition unit 811 receives the output value V transmitted from the stroke sensor 171 (S503). In this case, the judgment unit 812 performs a process of determining the acquired output value (S505).

In the case where the output value is V2 (or a value ranging from V3 to V4) (S507; Yes), the sound source control signal generating unit 813 generates a signal (sound source control signal Ct1) that changes the performance sound corresponding to the half pedal area (S509). The transmission unit 815 transmits the sound source control signal Ct1 to the sound source unit 84 (S511).

If the output value is not V2 (or a value ranging from V3 to V4) but is larger than V4 (S513; Yes), the sound source control signal generating unit 813 generates a signal (S515) that gives a change to the performance sound corresponding to the end position area (sound source control signal Ct2). The transmission unit 815 transmits the sound source control signal Ct2 to the sound source unit 84 (S517).

If the output value does not correspond to the above (S513; No), the sound source control signal may not be generated. At the point when the respective processes are completed, the process returns to S503 again. In addition, although the case where the foot lever is rotated in the direction from the rest position to the end position has been shown in the above description, the same applies to the case where the foot lever is rotated in the direction from the end position to the rest position. In this case, the control unit 81 may process the output value V2 (or the output values V3 to V4) calculated above.

In the present embodiment, the performance sound is changed in the half pedal area by using the information detected by the rotation sensor 172 and the output value and the offset information corresponding to the position of the foot lever 100 detected by the stroke sensor 171. As a result, even in the case where a shape variation, a change in age, or the like of the elastic member occurs, it is possible to adjust (calibrate) the position of the foot lever, in particular, the position of the foot lever in the half pedal area (depression amount), the change in the reaction force with respect to the foot lever, and the change in the performance sound in real time.

Therefore, as in the case of depressing the damper pedal of the acoustic piano, the performance sound can be changed in accordance with the change in the reaction force. That is, by using the present embodiment, it is possible to stabilize the change in the position of the pedal, the change in the load on the pedal, and the change in the performance sound.

It is preferable that the position of the tip 100fe in the second area 100f of the foot lever 100 in the half pedal area includes a range within 5 mm before and after, more preferably a range within 2 mm before and after, in the rotation direction with reference to a position where the reaction force from the elastic member 166 is applied to the foot lever 100 by a 0.5 kg or more. In this area, the user can change the performance sound while feeling a moderate reaction force, so that the user can perform the desired performance.

In the present embodiment, although an example has been described in which the rotation sensor 172 detects the rotation amount of the elastic member 166 when the elastic member 166 comes into contact with the protruding portion 167 in a state where the foot lever 100 is in the middle of moving from the rest position to the end position, the present disclosure is not limited thereto. The rotation sensor 172 may detect the movement of the elastic member in a non-contact manner.

### Fifth Embodiment

In the present embodiment, an example in which the configurations of the first embodiment and the third embodiment are combined will be described.

In the present embodiment, the control unit may store the information detected by the contact sensor 173 in the memory unit when the predetermined condition is satisfied. In this example, the first rotation by the foot lever 100 when the electronic keyboard device 1 electrically connected to the foot lever 100 is activated is mentioned as the predetermined condition.

At the time of the first rotation of the foot lever 100 when the electronic keyboard device 1 is activated, the contact sensor 173 detects information interlocked with the movement of the elastic member 165A. For example, the contact sensor 173 may detect the contact with the protruding portion 161 of the elastic member 165A. In this case, the position (stroke St) of the foot lever 100 is detected as the output value Vt by the stroke sensor 171. The control unit 81 calculates the output value V2 (V3 and V4) using the output values Vt and the offset Voffset as described in the third embodiment. These pieces of information are stored in the memory unit 82 and remain stored until the electronic keyboard device 1 is powered off. Therefore, by using the present embodiment, it is possible to stabilize the change in the position of the pedal, the change in the load on the pedal, and the change in the performance sound while reducing the load applied to the contact sensor 173 and the control unit 81.

In addition, in the present embodiment, although the contact sensor 173 detects that the contact sensor 173 is in contact with the protruding portion 161 of the elastic member 165A, the present disclosure is not limited thereto. The contact sensor 173 may detect contact between the first area 100r of the foot lever 100 and the elastic member 165A.

In the present embodiment, although an example has been described in which the control unit 81 stores the output value V2 (or the output values V3 and V4) in the memory unit 82 at the time of the first rotation by the foot lever 100 when the electronic keyboard device is activated, the present disclosure is not limited thereto. For example, the output value V2 (or the output values V3 and V4) may be stored in the case where the rotation speed of the foot lever 100 satisfies a predetermined condition. In this embodiment, the control unit 81 may store the output value V2 (or the output values V3 and V4) in the memory unit 82 when the rotation speed of the foot lever 100 is slower than the set speed.

Further, the setting may be performed based on an operation signal input from the user to the operation unit 83. For example, when the user inputs an operation signal CS for setting the “setting mode” to the operation unit 83, the control unit 81 may store the output value V2 (or the output values V3 and V4) in the memory unit 82. In the “setting mode”, the control unit 81 stores the output value V2 (or the output values V3 and V4) each time the foot lever 100 rotates. When the user releases the setting mode, a signal for changing the performance sound is generated when the foot lever 100 is operated later by using the last stored first information and second information.

Further, in the present embodiment, the control unit 81 may acquire in advance an output value (for example, a voltage value) of the stroke sensor 171 at the time of initial rotation of the foot lever 100 and contact detection by the contact sensor 173. In this case, the control unit may estimate an output value (voltage value) at the time of a full stroke. Accordingly, it is possible to obtain an output value (voltage value) corresponding to the stroke amount in the vicinity of the end position without being affected by the variation of the stroke sensor 171 (variable resistor).

### [Modification]

The present disclosure is not limited to the embodiments described above, and includes various other modifications. For example, the embodiments described above have been described in detail for the sake of easy understanding of the present disclosure, and are not necessarily limited to those having all the described configurations. Other configurations may be added, deleted, or substituted for some of the configurations of the embodiments. Hereinafter, although the first embodiment will be described as a modified example, other embodiments can also be applied as a modified example.

Further, in the first embodiment of the present disclosure, although the control unit 81 and the memory unit 82 are arranged on the keyboard body 91 side, the present disclosure is not limited thereto. For example, the control unit 81 or a part of the memory unit 82 may be arranged in the pedal unit 10. As a result, it is possible to replace just the pedal unit. In addition, adjustment at the time of a pedal unit failure is facilitated.

Further, in the first embodiment of the present disclosure, although an example has been described in which the stroke sensor 171 uses an exemplary variable resistor, the stroke sensor 171 may include an optical sensor for measuring the position of the first area 100r (displacement from the reference position). The optical sensor can detect the position of the foot lever 100 (stroke amount) using the reflected light.

In the first embodiment of the present disclosure, although the elastic member 165 is a rubber member, the present disclosure is not limited thereto. For example, the elastic member 165 may have the same spring shape as the elastic member 155, and may be configured to be elastically deformed.

Further, in the first and third embodiments of the present disclosure, although an example in which the elastic member 155 and the elastic member 165 are used as the reaction force member has been described, the present disclosure is not limited thereto. The reaction force member is appropriately used as long as it can apply a reaction force to the foot lever. For example, the reaction force member may be a member that provides gravity or a member that provides a frictional force.

Further, in the third embodiment of the present disclosure, although an example in which the elastic member 165A is arranged so as to cover the detecting position (the sensing unit 173a) of the contact sensor 173 from below is shown, the present disclosure is not limited thereto. For example, the elastic member 165A may be arranged on the foot lever 100. In this case, the protruding portion 161 may not be arranged inside the elastic member 165A, and a conductive material may be arranged at the outer tip of the elastic member 165A. As a result, when the foot lever 100 is rotated, the outer end portion of the elastic member 165A comes into contact with the detecting position of the contact sensor 173, so that the contact sensor 173 can output a predetermined detection signal. In addition, in the case where the elastic member 165A is arranged with a conductive material at an outer end portion thereof, ON/OFF information may be acquired by a sensor (for example, a range sensor) that differs from the contact sensor 173.

In the first embodiment of the present disclosure, although the case 190 is exemplified as an example of the structure of the integrated structure, the present disclosure is not limited thereto. For example, a circuit board may be used as the structure of the integrated structure. The circuit board may be arranged on the case. In this case, the stroke sensor 171 and the elastic member 165 are arranged on the circuit board. In the fourth embodiment, the stroke sensor 171 and the rotation sensor 172 may be arranged on the circuit board.

Further, according to an embodiment of the present disclosure, the pedal device may include a memory unit configured to store the first information, and a control unit configured to transmit a first signal that changes the performance sound based on information of the first position of the foot lever detected by the first sensor and the first information stored in the memory unit.

In addition, in the pedal device according to an embodiment of the present disclosure, the first information may be stored according to a rotation status of the foot lever.

In addition, according to an embodiment of the present disclosure, unlike the first sensor, the pedal device may include a second sensor different from the first sensor and configured to detect the first information, and a control unit configured to transmit a first signal that changes the performance sound based on information of the first position of the foot lever detected by the first sensor and the first information detected by the second sensor.

Further, in the pedal device according to an embodiment of the present disclosure, the foot lever may further rotate from the first position to a second position corresponding to a preset offset, and the first signal is transmitted when the first sensor detects the second position.

In addition, in the pedal device according to an embodiment of the present disclosure, the reaction force member may have a center of rotation, and the second sensor may acquire the first information based on an amount of rotation of the center of rotation of the reaction force member.

In addition, in the pedal device according to an embodiment of the present disclosure, the control unit may store the first information detected by the second sensor in the memory unit when a predetermined condition is satisfied.

Further, in the pedal device according to an embodiment of the present disclosure, the control unit may transmit the first signal to the sound source unit when the information of the first position of the foot lever detected by the first sensor reaches the threshold value of the first sensor and the second sensor does not detect the first information.

In addition, in the pedal device according to an embodiment of the present disclosure, the first sensor may extract the information about the position of the foot lever based on a predetermined condition.

Further, in the pedal device according to an embodiment of the present disclosure, the first information stored in the memory unit may be information set based on a change in the reaction force or a contact state between the foot lever and the reaction force member.

In addition, in the pedal device according to an embodiment of the present disclosure, a position of a tip of the second portion in the foot lever when making a change to the performance sound includes a range within 5 mm before and after a position where 0.5 kg or more of a reaction force is applied.

Further, in the pedal device according to an embodiment of the present disclosure, the pedal device may include an acquisition unit configured to acquire a signal for rewriting the first information.

Further, in the pedal device according to an embodiment of the present disclosure, the rewritten first information may be reset to the first information before being rewritten based on a reset signal input by an operation from a user.

In addition, in the pedal device according to the embodiment of the present disclosure, the reaction force member may be a dome shape elastic member.

Further, in the pedal device according to an embodiment of the present disclosure, the predetermined condition may be a first rotation of the foot lever when the keyboard body electrically connected to the foot lever is activated.

In addition, in the pedal device according to an embodiment of the present disclosure, the structure may be either the case or a circuit board.

Further, in the pedal device according to an embodiment of the present disclosure, the structure may be the circuit board, the reaction force member may include a second sensor, and the first sensor and the second sensor may be arranged on the circuit board.

In addition, in the pedal device according to an embodiment of the present disclosure, the structure may be the case, and the first sensor and the reaction force member may be arranged adjacent to each other on the same surface of the case.

What is claimed is:

1. A pedal device for an electronic musical instrument, the pedal device comprising:
a case;
a foot lever including a first portion located inside the case and a second portion located outside the case, wherein:
the foot lever is rotatably arranged with respect to the case; and
a center of rotation of the foot lever is located between the first portion and the second portion;
a first sensor configured to detect a position of the foot lever between a rest position and an end position;
a first reaction force member that:
contacts the foot lever and applies a reaction force as the foot lever rotates from the rest position to the end position; and
is located in a portion of a side opposite to the center of rotation of the first portion; and
a control unit including a processor configured to, in a state where the first reaction force member is in contact with the foot lever and the detected position of the foot lever:
calibrate the position of the foot lever that changes a performance sound in response to change in the reaction force based on first information set based on a first position of the foot lever and information relating to the position of the foot lever detected by the first sensor.

2. The pedal device according to claim 1 further comprising:
a memory unit storing the first information,
wherein the control unit is configured to transmit a first signal that changes the performance sound based on the detected first position of the foot lever and the first information stored in the memory unit to a sound source unit including a signal processor.

3. The pedal device according to claim 2, wherein the first information is stored according to the detected position of the foot lever.

4. The pedal device according to claim 1, further comprising:
a second sensor different from the first sensor and configured to detect the first information,
wherein the control unit is configured to transmit a first signal that changes the performance sound based on the detected first position of the foot lever and the detected first information to a sound source unit including a signal processor.

5. The pedal device according to claim 4, wherein:
the foot lever further rotates from the first position to a second position corresponding to a preset offset, and
the first signal is transmitted after the first sensor detects the second position.

6. The pedal device according to claim 4, wherein
the first reaction force member has a center of rotation; and
the second sensor acquires the first information based on an amount of rotation of the center of rotation of the reaction force member.

7. The pedal device according to claim 4, wherein the control unit stores the first information detected by the second sensor in the memory unit, in a state where a predetermined condition is satisfied.

8. The pedal device according to claim 4, wherein the control unit transmits the first signal to the sound source unit, in a state where the detected first position of the foot lever reaches a threshold value of the first sensor and the second sensor does not detect the first information.

9. The pedal device according to claim 1, wherein a position of a tip of the second portion in the foot lever, in changing the performance sound, includes a range within 5 mm before and after a position where 0.5 kg or more of a reaction force is applied thereto as a reference.

10. The pedal device according to claim 1, wherein the first sensor extracts information relating to a position of the foot lever based on a predetermined condition.

11. The pedal device according to claim 1, wherein the first sensor and the reaction force member are arranged on the case, which has an integral structure.

12. A pedal device for an electronic musical instrument, the pedal device comprising:
a case;
a foot lever arranged to be rotatable in the case;
a first sensor configured to detect a position of the foot lever between a rest position and an end position; and
a first reaction force member contacting the foot lever and applying a reaction force as the foot lever rotates from the rest position to the end position,
wherein the first sensor and the first reaction force member are arranged on the case.

13. The pedal device according to claim 12, wherein the first sensor and the first reaction force member are arranged adjacent to each other on the same surface of the case.
